(19) United States
(12) Patent Application Publication
(10) Pub. No.: US 2009/0064196 A1
(43) Pub. Date: Mar. 5, 2009

(54) MODEL BASED DEVICE DRIVER CODE GENERATION

(75) Inventors: John Richardson, Sammamish, WA (US); Peter W. Wieland, Seattle, WA (US)

Correspondence Address: MICROSOFT CORPORATION, ONE MICROSOFT WAY, REDMOND, WA, 98052-6399, US

(73) Assignee: MICROSOFT CORPORATION, Redmond, WA (US)

(21) Appl. No.: 11/848,910

(22) Filed: Aug. 31, 2007

(51) Int. Cl. G06F 3/00

(52) U.S. Cl. 719/327

(57) ABSTRACT

A driver model is generated that describes the configuration of one or more driver objects. The driver model and developer driver code are compiled to generate a driver including a machine readable driver model and compiled developer driver code, wherein the machine readable driver model and the complied developer driver code are independently serviceable.

### BACKGROUND

Drivers are complex, event driven pieces of software. Typically, when a new driver is created, its organization tends to follow a common pattern, but has device specific customization requirements. The way it is customized today is to use “cut and paste” of sample code taken from existing drivers. This is error prone, and updates to the original driver are not automatically reflected into the driver. This causes any bugs to become “long lived” across many drivers. There is a trend to providing application “templates” inside developer systems, but this just automates the “cut and paste” from a canned sample. Any developer customizations to this model are not re-validated as to correctness.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Embodiments of the invention are directed to model based device driver code generation. In one embodiment, a user creates a driver model that describes the configuration of one or more driver objects. The user may also designate developer driver code to be included in the driver. The driver model and the developer driver code are compiled to bind the driver model to any developer driver code. The driver model may also be validated against a set of driver usage rules that define proper driver behavior. The complied driver includes a machine readable driver model and compiled developer driver code that are individually serviceable.

Many of the attendant features will be more readily appreciated as the same become better understood by reference to the following detailed description considered in connection with the accompanying drawings.

### BRIEF DESCRIPTION OF THE DRAWINGS

Like reference numerals are used to designate like parts in the accompanying drawings.

FIG. 1 is a block diagram of a model based device driver code generation tool in accordance with an embodiment of the invention.

FIG. 2 is a flowchart showing the logic and operations of a model based device driver code generation tool in accordance with an embodiment of the invention.

FIG. 3 is a block diagram of a device driver produced by a model based device driver code generation tool in accordance with an embodiment of the invention.

FIG. 4 is a flowchart showing the logic and operations of executing a device driver on a target system in accordance with an embodiment of the invention.

FIG. 5 is a block diagram of an example computing device for implementing embodiments of the invention.

### DETAILED DESCRIPTION

The detailed description provided below in connection with the appended drawings is intended as a description of the present examples and is not intended to represent the only forms in which the present examples may be constructed or utilized. The description sets forth the functions of the examples and the sequence of steps for constructing and operating the examples. However, the same or equivalent functions and sequences may be accomplished by different examples. While embodiments herein are described in relation to object-oriented programming, it will be understood that embodiments of the invention may be implemented using other programming environments.

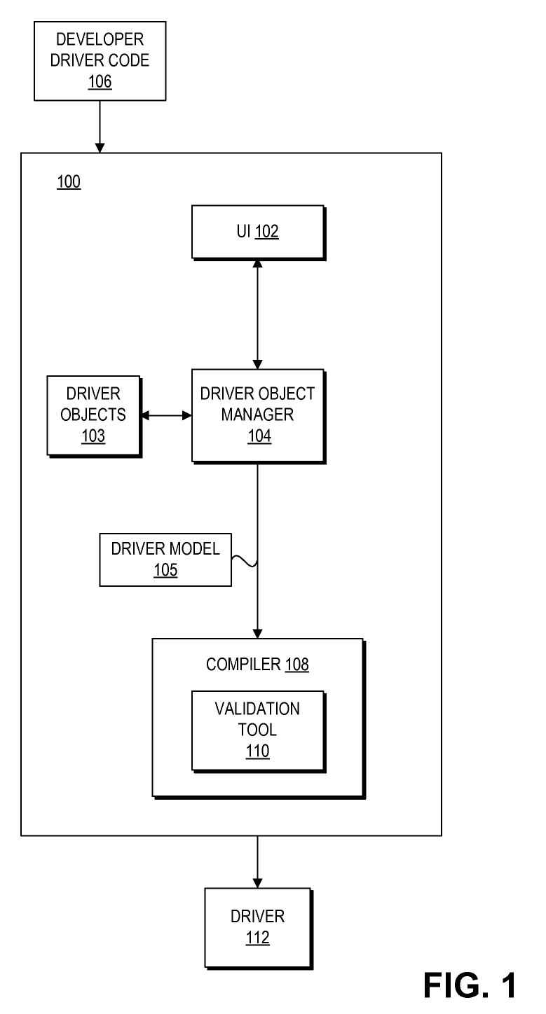

FIG. 1 shows a model based device driver code generation tool 100 in accordance with an embodiment of the invention. In one embodiment, one or more components of tool 100 may be implemented by computer readable instructions executable by one or more computing devices. In one embodiment, tool 100 may be used by a device driver developer to create a device driver for a device.

Tool 100 includes a driver object manager 104. Driver object manager 104 lets the user (e.g., a device driver developer) choose pre-defined driver objects 103 for their driver project. The user may also use driver object manager 104 to configure the properties and options as to how the device driver is organized, responds to system events, and when to invoke developer supplied code for device specific operations. Driver object manager 104 generates a driver model 105 which describes the driver. In one embodiment, driver model 105 is described using an eXtensible Driver Markup Language (XDML) discussed below. Driver object manager 104 may also be used to construct “software drivers” that interact with another driver in place of the actual hardware.

Driver object manager 104 may be used to configure one or more driver objects 103 selected by the user. Driver objects 103 include various objects that are common to device drivers. In one embodiment, a driver object is an object-oriented programming (OOP) object that may have properties and methods. Driver object manager 104 allows the user to set the properties and methods for a driver object. Examples of a driver object include a Driver that represents the program module to handle a class or type of device, such as a SCSI disk. Another example driver object includes a Device that is a specific instance of the device handled by the driver. For example, a single Driver may have multiple instances of the device, such as a set of unique SCSI disks handled by the same driver. Another example of a driver object includes a Queue which is an object representing a queue of requests for a specific device. In an implementation of the XDML model (discussed below), a Driver object is a parent encompassing all the Device objects, while a Device object may be a parent having one or more Queue objects to represent the stream of requests to service. This is a containment relationship, not an inheritance relationship.

In one embodiment, driver objects 103 may be grouped in device categories. For example, driver objects for storage devices may be in one category while driver objects for network communication devices may be in another category. Graphical representations of driver objects may be displayed in categories in UI 102 for ease of use.

By selecting driver objects via tool 100, the developer is ensured of using updated, tested, and OS-developer approved driver objects. This avoids the problem of cutting and pasting code from previous drivers and perpetuating outdated or buggy driver objects from old drivers. In one embodiment, tool 100 may periodically contact a server (not shown) for updating driver objects 103 with the latest driver objects for use with various operating systems.

The user may also define events for a driver object. In one example, an event is associated with developer driver code 106 that includes an event handler for responding to the event. The developer may write developer driver code 106 for managing specific activity of the associated hardware device. In one embodiment, developer driver code 106 is source code that is compiled by compiler 108.

In one embodiment, tool 100 may be supported by a driver code generation user interface (UI) 102. Through UI 102, a user may select graphical representations of driver objects 103. The user may then use UI 102 to configure the driver objects. UI 102 may also be used to describe the interaction between a driver object and other driver objects as well as the driver object's interaction with developer supplied driver code 106.

In one embodiment, driver model 105 does not include actual driver code, but is a description of the driver for driver objects. The actual driver objects may be provided by a driver library stored on the target system for the driver. The target system may be described in terms of the system architecture and operating system that the driver is written for (e.g., 32-bit Microsoft Windows® executing on an x86 processor). The driver objects are known to the target system.

When the driver is installed or executed on the target system, the driver objects from the driver library on the target system are configured in accordance with driver model 105. This way, the library driver code is separately serviceable and independent from the developer driver code. Thus, a driver developer (such as an OEM) may update their developer driver code on the target system without breaking the code for the driver objects. Similarly, the driver objects library on the target system may be updated separately and independently from the developer driver code.

After the user has configured the driver objects and optionally designated developer driver code for the driver, the user may then build driver 112 using compiler 108. Complier 108 binds developer driver code 106 to driver model 105. In one embodiment, compiler 108 binds the objects' properties, methods, and events in driver model 105 to developer driver code 106. Compiler 108 reads the driver description in driver model 105 and generates the operating system binding information for the target system to bind the developer's driver code to what is needed to implement the driver against the driver libraries on the target system. Driver 112 generated by compiler 108 may include “binding code” that includes code for the binding of the driver model to the developer driver code.

In one embodiment, driver 112 output by compiler 108 includes a machine readable version of driver model 105 and complied developer driver code. Driver 112 is native executable code ready for execution on the target system. This would be an “early binding” implementation.

In another embodiment, driver 112 is released in a neutral form, such as Intermediate Language (IL), similar to the Microsoft .NET framework. In this embodiment, driver 112 does not include binary code. The binary will be generated on the target system. Installation of driver 112 on the target system triggers a Just In Time (JIT) compiler which would bind it to the target system libraries and cache it for execution as a native image. Future updates to the driver can re-do this step at servicing time. This is “late binding” on the target system. Since drivers typically need to be active before the rest of the system is, the JIT at installation time is sometimes referred to as an “ahead of time” compiler to distinguish from pure Java style JIT and typical developer time final compilation. Late binding allows servicing of the driver dependencies (driver model and system libraries) without re-compiling the driver back at the original developer's workstation. For some systems and/or drivers, a native driver is required to start the system before the JIT compiler is available. This may be done offline in a “system generation” tool.

In yet another embodiment, the high level description template is “compiled” into a compact form, and provided alongside driver 112 in order to provide additional information on the driver's structure. This driver “metadata” (which may include data about the developer's code) would allow more flexible binding decisions to be made on the target system.

In one embodiment, compiler 108 generates a “code behind” file for the driver (and may be included in driver 112). The code behind file includes the developer driver code 106 authored by the driver developer. In an XDML implementation, this code behind file includes the event handlers specified in the XDML driver model. In one implementation, when the code behind file is bound to the driver model library, “binding code” is generated to perform this binding. This binding code may be optionally viewed by the developer. Compiler 108 binds the developer's code behind file code to driver model 105, and the binding is usually target system specific.

In one embodiment, compiler 108 may include a validation tool 110. In one embodiment, driver model 105 is validated against Windows Driver Model (WDM) usage rules for proper driver behavior. In another embodiment, developer driver code 106 may be validated in addition to driver model 105. Example driver usage rules include the order some driver operation must occur, what locks may be used, paging rules, and so on. If driver model 105 is valid, then compiler 108 generates machine readable code to implement the model. This code is separate from any developer driver code. This allows updates to the driver model and re-generation of code from the driver model without wiping out the developer's work. In addition, updates to the driver model may be provided to fix identified issues and bugs, and tool 100 may re-compile the driver to “fix” the driver automatically, with minimal, if any impact on the developer driver code.

Driver model 105 may also be input into other validation tools, such as Static Driver Verifier (SDV), to further validate the driver model. The higher level description would allow these tools to be more effective. The driver model makes SDV's work easier, since the model of the driver is available at a higher level, and the developer's code is forced to follow a pattern dictated by the driver model. One of the hardest parts of driver validation is identifying what the behavior for a function should be, so the function's code sequences may be validated. Since the driver model provides the mapping from the model to the driver's functions in the code behind file, determining this is straightforward, and SDV now knows what behavior it should be validating against.

It will be appreciated that by using tool 100, a device driver developer does not have to touch source code (other than developer driver code 106) to create a driver. The developer merely has to configure predefined driver objects. The developer does not have to cut and paste code from old drivers which often creates bugs nor does the developer have to start writing a driver from a blank sheet. The developer can safely build a driver from tool 100 using updated and pre-tested driver objects. Also, the driver may be validated for compliance with driver usage rules during compiling instead of later in the driver development process.

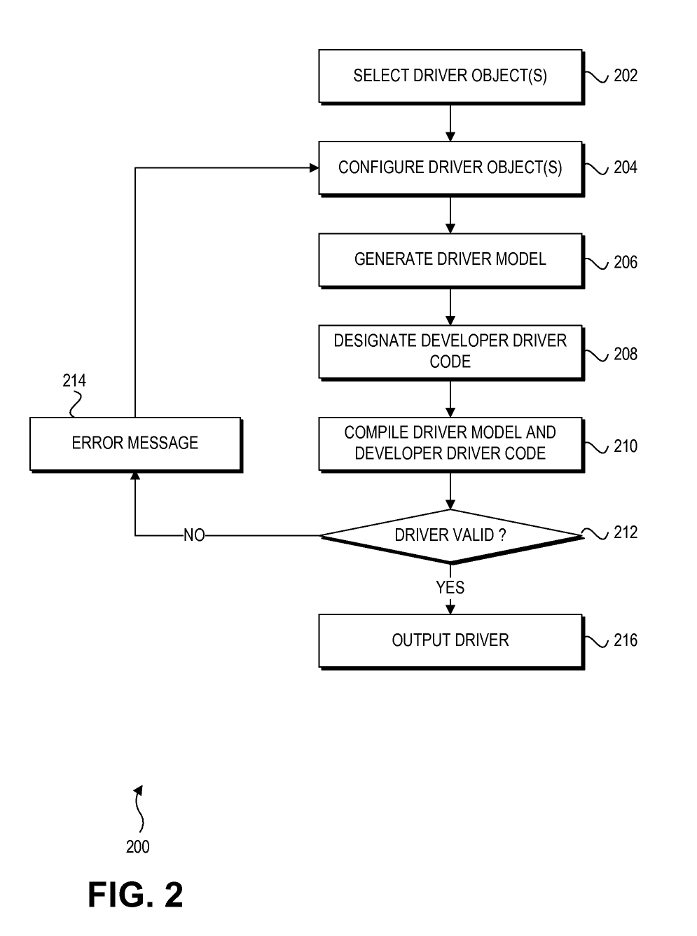

Turning to FIG. 2, a flowchart 200 shows the logic and operations of creating a device driver using model based device driver code generation in accordance with an embodiment of the invention. In one embodiment, at least a portion of the logic of flowchart 200 may be implemented by computer readable instructions executable by one or more computing devices.

Starting in block 202, a user selects one or more driver objects. Continuing to block 204, the user configures the one or more driver objects. In one embodiment, the user selects and configures the driver objects via a graphical UI. In one embodiment, the user is not manipulating the actual driver objects, but representations of the driver objects. The code for the driver objects will be provided by a library on the target system. Next, in block 206, a driver model is generated that describes the configurations of the driver objects.

Proceeding to block 208, the user may choose to designate developer driver code to be added to the driver. Next, in block 210, the driver model and the developer driver code are compiled to generate a driver. During compiling, the driver model is bound to any developer driver code. The driver model is transformed into a machine readable version and the developer driver code is compiled from source code. In one embodiment, the developer driver code is compiled into an intermediate language and will be compiled again by the target system into machine code.

Proceeding to decision block 212, the logic determines if the driver is valid when compared to one or more driver usage rules. If the answer is yes, then the driver is output in a driver file, as shown in block 216. In one embodiment, the compiler may also output a code behind file for the driver.

If the answer to decision block 212 is no, then the logic proceeds to block 214 where an error message is presented to the user. In one embodiment, the error message includes information about the driver usage rule violated and/or suggested action to correct the error. After block 214, the logic returns to block 204 where the user may re-configure of one or more driver objects to correct the validation error.

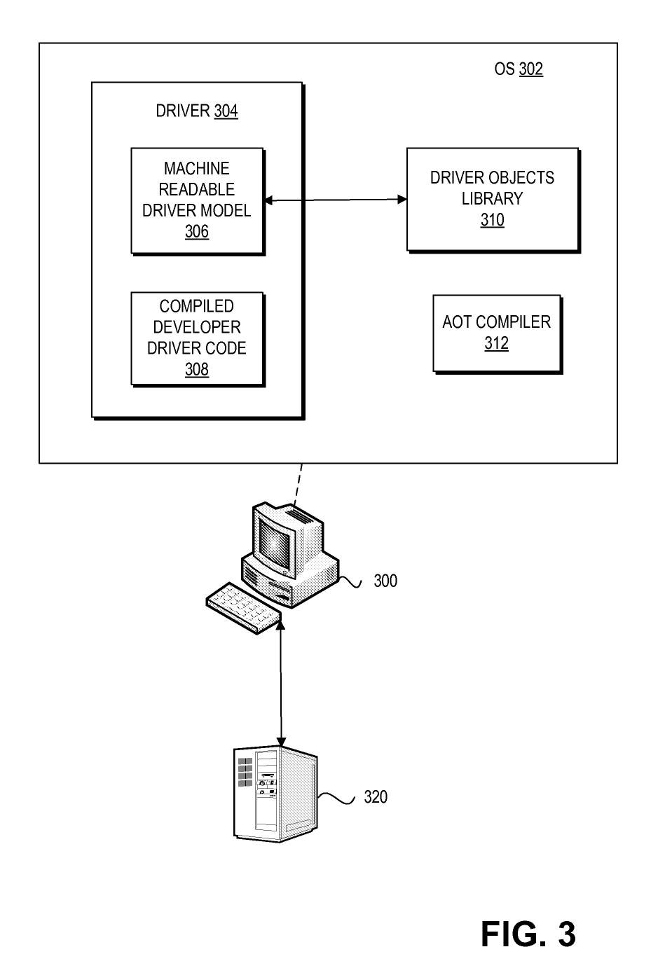

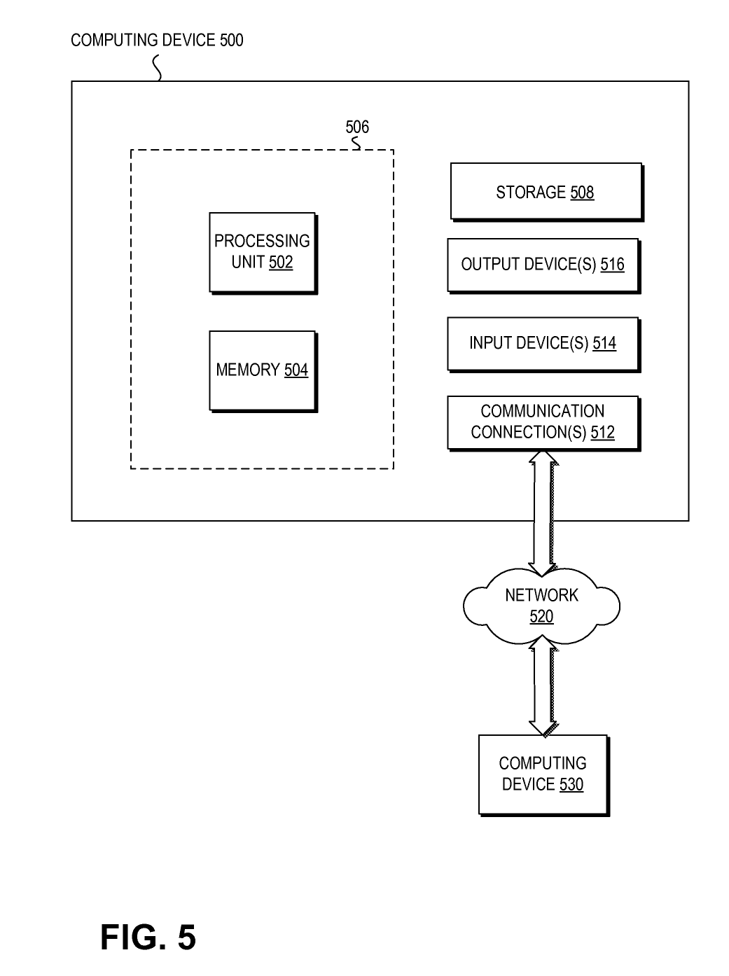

Turning to FIG. 3, a device driver 304 is shown that has been constructed with model based device driver code generation tool 100 in accordance with an embodiment of the invention. FIG. 3 shows a target system 300 that executes operating system (OS) 302 and has received device driver 304. For example, a user has attached a new hardware device to target system 300 and has downloaded device driver 304 for the new hardware device. In one embodiment, target system 300 includes a computing device as described below in connection with FIG. 5.

Driver 304 includes a machine readable driver model 306 and compiled developer driver code 308. Machine readable driver model 306 includes a machine readable version of the driver model as generated by compiler 108. Machine readable driver model 306 is used to configure driver objects stored in library 310 that is already present in operating system 302. In one embodiment, compiled developer driver code 308 includes an Intermediate Language (IL) assembly, such as a Microsoft .NET assembly. The IL assembly is compiled again into machine language for execution on target system 300.

In one embodiment, an Ahead of Time (AOT) compiler 312 on target system 300 brings the driver library code (e.g., an intermediate language) of library 310 and developer driver code 308 (e.g., an intermediate language) together for execution. In one embodiment, system 300 may check for updates to machine readable driver model 306 or compiled developer driver code 308, such as by communicating with server 320, prior to compiling driver objects in library 310 described by machine readable driver model 306 or compiled developer driver code 308.

In one embodiment, compiled developer driver code 308 is verified as a safe IL assembly. In one embodiment, code 308 is present in an intermediate language file that conforms to a well known set of “type safe” patterns, and does not have any direct to native or “unsafe” functions. It will be appreciated that embodiments herein do not have to be limited to only safe drivers. For example, embodiments herein may be used to generate unsafe C drivers for Windows Driver Foundation's Kernel Mode Driver Framework (KMDF).

In another embodiment, since device drivers control hardware, the safety check may be moved down to hardware controls as well. For example: 1) validating the driver's code against a model of the hardware; 2) using the description of the driver's resources and operations and ensuring that hardware firewalls are in place to limit the scope of what the driver can do for any given request. The firewalling may be performed by operating system virtualization technologies such as Hypervisors.

This safety verification may help ensure system integrity as well as system security. For example only drivers that are verified as safe are loaded into the OS kernel space. If driver 304 is not verified as safe, then it is loaded into user space in hardware protected address space. An unsafe driver loaded into kernel space may overwrite kernel memory and cause a system crash. Further, a kernel memory overwrite error may be used to exploit target system 300. Traditionally, target system 300 is still vulnerable while a patch is written and distributed for the faulty driver. By using embodiments herein, even though driver 304 may have a memory overwrite bug, driver 304 may be kept out of kernel space.

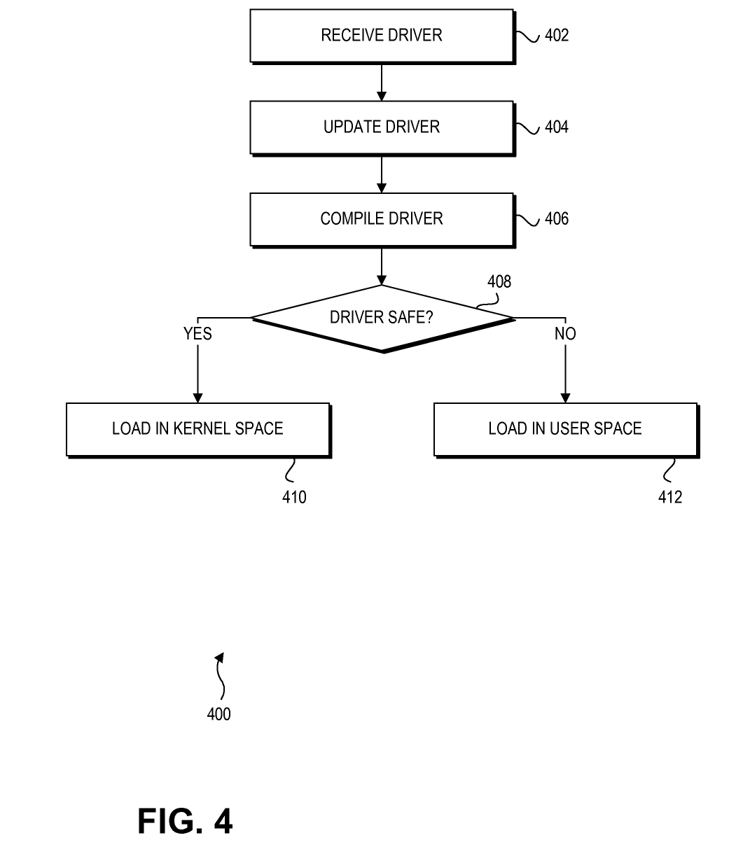

Turning to FIG. 4, a flowchart 400 shows the operations and logic of executing a device driver created with tool 100 in accordance with embodiments herein. Starting in block 402, the driver is received by the target system. The driver may be received from a computer readable medium, such as a Compact Disc (CD), over a network connection, and the like. Next, in block 404, the driver is updated, if updates are available. In one embodiment, target system 300 may communicate with a server 320 to determine if updates are available for machine readable driver model 306 and/or compiled developer driver code 308. Updates may also be checked for driver objects in library 310. It will be appreciated that machine readable driver model 306 and compiled developer driver code 308 may be serviced (e.g., updated) independent of each other. Driver updates may be checked each time the target system is booted, periodically while the target system is running, or by other scheduling schemes.

Next, in block 406, the driver is compiled on the target system. Compiling the driver may include configuring driver objects stored in library 310 in accordance with machine readable driver model 306. In one embodiment, the driver objects in library 310 are in an IL and are compiled into machine language by AOT compiler 312 in accordance with the configuration described in driver model 306. Compiled developer driver code 308 may also be in an IL that is compiled by AOT compiler 312. In one embodiment, the driver is compiled at driver installation time and cached, and a check may be done at each boot and/or start of the driver to see if it is up to date. In most cases, the driver would be up to date and a re-compilation of the driver would be skipped. In another implementation, the Windows Update (WU) service periodically checks if the driver is up to date against a WU server. When the driver needs updating, the WU service downloads and updates the driver which could include re-compilation of the driver. This approach resolves an issue with boot start device drivers which must be started before the compiler is available. The driver may be started from the cached image, and updated for the next restart once the system is running (however, in some cases, it's possible to restart a driver without restarting the computing device).

Proceeding to decision block 408, the logic determines if the driver is safe. In one embodiment, safety checks are performed by a compiler, such as AOT compiler 312, prior to the actual compilation of the driver. If driver is verified safe, then the driver is loaded and executed in kernel space, as shown in block 410. If the driver is not verified safe, then the driver is loaded and executed in user space, as shown in block 412. The driver may be loaded in a hardware protected memory space to prevent the driver from overwriting kernel memory.

Embodiments in a Windows Driver Foundation Environment

The following discusses embodiments of the invention implemented in a Microsoft® Windows® Driver Foundation (WDF) environment. However, one skilled in the art having the benefit of this description will appreciate that embodiments of the invention are not limited to WDF implementations. WDF includes a group of components that support the development, deployment, and maintenance of kernel-mode and user-mode drivers. The WDF model supports the creation of object-oriented, event-driven drivers.

In one instance, under WDF, device driver code generation tool 100 uses an eXtensible Driver Markup Language (XDML). XDML closely follows the eXtensible Application Markup Language (XAML) or Windows Presentation Foundation (WPF) markup language. XDML is an XML language that allows the description of not just GUI objects, but a general object hierarchy.

Today, when a driver developer customizes a sample driver to their solution, there is still a lot of cutting and pasting of code. WDF has reduced the code that must be cut and pasted, but its objects and configurations have their own set of rules. Many times the initial code of a driver is created from code snippets drawn from multiple samples to construct the driver configuration specific to the device. Since wholesale checking is not done against the specific configuration, many errors can creep into drivers in which the environment the code is copied into has changed.

By using model based device driver code generation tool 100, the driver developer “customizes” their default driver template by assigning properties to pre-defined WDF driver objects. In one embodiment, the driver developer “customizes” their default driver template by cutting and pasting XML elements from the sample XDML file(s), and adding elements to represent WDF objects and configurations they require. Tool 100 then validates the driver model as a whole before generating the driver template (e.g., driver 112). This ensures driver templates start from correct WDF models. In one embodiment, this may be done in an interactive visual design environment (e.g., UI 102), such as Microsoft® Visual Studios type environment.

In a Graphical User Interface (GUI) environment, the XDML file itself is customized, and validated so errors may be promptly displayed to the user. The XDML file is a description that has to be placed with the developer's code behind file to generate a working driver (binary or Intermediate Language). The GUI environment can assist in graphically constructing the drivers object model, and then allow the developer to “drop in” developer code.

Tool 100 also makes it easier for the driver developer to update their drivers with new recommended (or required) programming practices and bug fixes. This is further enabled by the “code behind” file used to separate the generated template driver code from OEM driver developer written code (e.g., event handlers). Thus, the driver model is isolated from the developer code. This “code isolation” scheme allows the driver model and the developer code to be individually serviceable.

In some early experiences with developers using WDF sample drivers, there still are basic “cut and paste” errors in which a driver developer starts with a sample hopefully close to their drivers problem domain, and then adds in cut and pasted code snippets from other sample drivers that provide specific customized functionality. Even though WDF handles the basic system synchronization and behavior rules on behalf of the driver, the driver still must contend with WDF lifetime, configuration, and behavior rules. A model based device driver code generation tool as described herein can validate the proposed driver configuration before writing the code on behalf of the driver developer, catching such errors even earlier in the design cycle.

In .NET programming, the XML namespaces can be declared to map to a specific .NET namespace, and regular .NET class patterns for construction, properties, and events can be expressed, and used to generate code to provide a runtime representation. The syntax of the XDML is designed to allow standard text editors to manipulate it (e.g., notepad, etc.), but since its structured XML, enables ease of generation and interpretation by tools, such as a visual designer contained within Microsoft® Visual Studio®.

Even though drivers are not necessarily represented as a set of .NET classes, the idea maps very well to the WDF model in which WDF objects have hierarchical relationships, as well as having regular patterns for construction, properties, and events.

XDML maps a specific WDF namespace which is interpreted to mean a WDF driver is being created. Regardless of output language choice, the namespace provides scope and meaning to the objects declared within the file, and these map to specific WDF objects. XDML will document specific language mapping details for the various XDML described constructs in the section for each language. This allows use of XDML with the Windows Driver Foundation's kernel mode and user mode driver frameworks (KMDF and UMDF) for Windows operating systems (such as Windows Vista), in addition to future use with isolated type safe languages, such as C#.

Mapping of XDML to WDF Object Model—The root document element of a driver template described in XDML is “XDMLDescription”. Child elements of XDMLDescription map to specific WDF objects, with the nesting level representing the parent-child relationships within the WDF object model. Attributes of the elements represent WDF object properties, in which the generated code may set these at creation time (constructor parameters), or at runtime (assignable properties). Non-present attributes represent WDF object defaults.

In many cases, WDF objects in a parent child relationship can refer to each other anonymously, without specific names at runtime. This is true in event handlers since the child objects handle is always supplied as the first parameter, and an object can only have one parent. But in some cases, the child object may need to be referred to by name. Examples are when multiple children are present, or when the child object handle is supplied as the target of some action, such as forwarding a request (WDFQUEUE), or activating a work item (WDFWORKITEM).

In order to identify such objects, a “Name=” attribute may be specified to allow the definition and naming of a WDFCONTEXT field in the parent object to store the handle of the WDFOBJECT represented by the element. Mappings of WDFCONTEXT entries to specific programming languages and runtimes are present in the sections on each language mapping.

Objects—XDML represents a WDF object hierarchy and their parent-child relationships.

Properties—XDML attributes represent WDF object properties, and values that may be set on them by the generated code.

Methods—Methods are defined by WDF object and are available at runtime to the driver. Some WDF object methods are invoked automatically by the generated code in order to represent behavior represented by the XDML file. The rules as to which methods are available when are specified by the specific WDF runtime the generated code is targeted to. Additional methods are created for objects represented by XDML in which the driver developer wants control over when they are created. These are called Factory Methods and are discussed further below.

Events—WDF object events are represented by XDML attributes with the OnEventName=“HandlerName” syntax. The presence of this attribute will define a WDF event callback with the name OnHandlerName in the generated code, with the proper WDF event registration taken care of automatically by the generated code.

Pseudo Events—These events do not exist in the WDF object model, but are an artifact of the flexibility in XDML. XDML allows the driver developer to specify code to be invoked at the beginning of the creation of any object generated by XDML, and to be invoked at the end of any such automatically generated initialization code. This is optional, and is represented by the OnPreInitialize( ) and OnPostinitialize( ) events. If either of these are not specified for a given object, the calls to them are not generated so there is no overhead in the generated code.

Context Memory—WDF specifies a context memory concept. This is driver developer defined storage to be associated with a WDF object in a structure. XDML will automatically generate the definition for a WDF context memory if required, and define fields to hold the handlers, or pointers to objects which the driver developer desires to refer to at runtime. The Name=“ObjectinstanceName” syntax in XDML will define a context field of name ObjectinstanceName in the context memory of the parent that will hold the object. The type of the field will be the proper type to hold the handle or the pointer.

Object Factory Methods—Typically, an object defined in an XDML file is automatically constructed at runtime when its parent is created. But in some cases the driver developer needs to have control as to when the object is in fact constructed. This is supported by specifying the attribute NoAutomaticCreation=“true”, and requires the presence of a Name=“ObjectinstanceName” attribute. This will define a factory method in the objects parent of “CreateObjectinstanceName” and this may be invoked by the driver at runtime.

In order to better understand XDML, an example mapping for KMDF and the C language follows (referenced as “KMDF 1.0C Toaster Example”). The following is an XDML driver model that includes an OnPreInitialize event handler.

```
<!-- Toaster.xdml -->
<XDMLDescription
  xmlns=“http://schemas.microsoft.com/wdf/nxgen/2006”
  xmlns:x=“http://schemas.microsoft.com/wdf/xdml/2006”>
<Driver
    OnPreInitialize=“OnPreInitialize”>
</Driver>
</XDMLDescription>
```

The above XDML driver model has the following associated developer driver code behind file for the OnPreInitialize event handler. In one implementation, when the XDML compiler is run the first time, a template for the code behind file is generated toaster.c.template. This may be copied to toaster.c in order to start the project.

```
#include “toaster.h”
NTSTATUS
EvtDriverPreInitialize(
  WDF_OBJECT_ATTRIBUTES* DriverAttributes,
  WDF_DRIVER_CONFIG* DriverConfig
  )
{
  return STATUS_SUCCESS;
}
```

The XDML compiler will generate the main driver boilerplate required for initialization, and this is linked with the developer defined code behind file that defines the essential event handlers' specific to the targeted driver's environment. When compiled, the example XDML file (that includes the XDML driver model and developer driver code described above) will generate the following driver code in a file named as toasterGeneratedFramework.c.

```
//------------------------------------------------------------------------------
// <auto-generated>
//  This code was generated by a tool.
//  XDML Compiler Version 0.1
//  From file toaster.xdml on 10/5/2006 9:26:20 PM UTC
//  Command Line: xdml <options> toaster.xdml
//
//  Changes to this file may cause incorrect behavior and will be lost if
//  the code is regenerated.
// </auto-generated>
//------------------------------------------------------------------------------
#include “toaster.h”
NTSTATUS
DriverEntry(
  PDRIVER_OBJECT DriverObject,
  PUNICODE_STRING RegistryPath
  )
{
  NTSTATUS status = STATUS_SUCCESS;
  WDF_OBJECT_ATTRIBUTES DriverAttributes;
  WDF_DRIVER_CONFIG DriverConfig;
  WDFDRIVER DriverHandle;
  WDF_OBJECT_ATTRIBUTES_INIT(&DriverAttributes);
  WDF_DRIVER_CONFIG_INIT(&DriverConfig, NULL);
  status = EvtDriverPreInitialize(&DriverAttributes, &DriverConfig);
  if (!NT_SUCCESS(status)) {
    return status;
  }
  status = WdfDriverCreate(
            DriverObject,
            RegistryPath,
            &DriverAttributes,
            &DriverConfig,
            &DriverHandle
            );
  if (!NT_SUCCESS(status)) {
    return status;
  }
  return status;
}
```

The following header is generated:

```
//------------------------------------------------------------------------------
// <auto-generated>
//  This code was generated by a tool.
//  XDML Compiler Version 0.1
//  From file toaster.xdml on 10/5/2006 9:26:20 PM UTC
//  Command Line: xdml <options> toaster.xdml
//
//  Changes to this file may cause incorrect behavior and will be lost if
//  the code is regenerated.
// </auto-generated>
//------------------------------------------------------------------------------
#if !defined(_toaster_H_)
#define _toaster_H_{—}
#include <ntddk.h>
#include <wdf.h>
#define NTSTRSAFE_LIB
#include <ntstrsafe.h>
#include “wmilib.h”
#include <initguid.h>
NTSTATUS
DriverEntry(
  PDRIVER_OBJECT DriverObject,
  PUNICODE_STRING RegistryPath
  );
NTSTATUS
EvtDriverPreInitialize(
  WDF_OBJECT_ATTRIBUTES* DriverAttributes,
  WDF_DRIVER_CONFIG* DriverConfig
  );
#endif // _toaster_H_{—}
```

Driver Model Checking in XDML

The XDML compiler checks the declared driver implementation described in the XDML file. This can be built into tool 100 (such as validation tool 110) or by outputting a file for running in a model-checking tool. In either case, the WDF model must be described to the driver model checker.

It is tempting to make a first cut of this by just writing C# code in the XDML compiler that enforces known “rules” about a KMDF or UMDF implementation. But while expedient, it is known that this is not maintainable over time. It is hard to understand the model by reading the C# code, and even harder to update and version the model for different framework releases.

In one embodiment, the driver model is represented as a set of tables within the XDML compiler, and this would allow easier maintenance. It would also put in place a mechanism for reading this table data from an external source, such as an XML based model file.

In one embodiment, a driver model file serves as an input into the driver model checker. In one implementation, this driver model is the operating system imposed model. The “rules” the compiler will check the developers XDML file against are captured in data, and not hard coded in the programming language. Driver model files would then be maintained for each version of WDF, and the proper one supplied as required. Driver models may differ based on type of device (e.g., storage disk, network, etc.), operating system version (e.g., Windows XP, Vista, etc.), or which mode of operation is targeted (e.g., user mode or kernel mode). It may be difficult to keep model tools up to date with different driver models as they are created, and the “model file” is a way to allow the models to be updated by people not familiar with the internals of the model tool(s).

Once we have a driver model file for a WDF implementation, its use may go beyond just an XDML driver model checker. For example, the driver model file may be inputted into a visual designer so improper relationships cannot be expressed to begin with.

In another example, driver model files may serve as SDV models for KMDF object interactions.

The driver model file may be input to either SDV validation of a concrete driver, or input to a tool that assists in the creation of SDV rules. The driver model file may be used with PREfast models.

In another example, the driver model file may be used with runtime verification within the WDF itself. Currently, WDF (KMDF specifically) has runtime code that validates it's model in both the normal case (basic API relationship's at object create time) and when in “verifier mode” which provides more extensive validation. Currently, this is hand written code that runs the risk of not validating the actual conceptual model present in a WDF driver model file. Conversely, the WDF driver model file has the risk that it may not accurately represent the specific WDF implementation in code. In one case, the driver model file can be used to generate runtime validation tables for a given WDF implementation.

The representation of the WDF driver model files may include some of the following attributes:
Spec# programming system or similar modeling language. This may, or may not be “weighty” providing more capability than we need. The syntax should be approachable with minimal training to developers familiar with C#, XML, driver development, etc.
SDV or similar rules syntax. These may be to specific to SDV itself, as opposed to being a general model description.
XML Schema Definition (XSD) (a language that enables one to define the structure and data types for XML documents) would allow modeling of XDML elements and attributes, and allowed combinations.
Domain specific XML syntax that describes the driver model. This is an expedient approach that avoids using code inside of the XDML compiler to represent the driver model, and could be used later on as a basis for a standards based model description.

XDML Code Model

The XDML compiler generates code that implements the main framework, or “template”, of a specific device driver configuration. As a driver is developed and the XDML file is updated, this code is re-generated. Due to the regeneration of the template implementation code, the driver developer should not edit these files, otherwise changes will be lost when build is run again and the file(s) are re-generated.

To solve this problem, code is separated into a “code behind” file (which the driver developer may edit) and the generated framework implementation files. The code behind file typically contains the event handlers for events specified in the XDML file (i.e., the driver model). To assist in the development of the code behind file, a template of a code behind file that properly handles all events is generated as part of the build process and placed with the generated files. This file ends with “.template” and is intended to be copied into the project without the “.template” extension to start an XDML driver project.

Example Computing Environment

FIG. 5 and the following discussion are intended to provide a brief, general description of a suitable computing environment to implement embodiments of the invention. The operating environment of FIG. 5 is only one example of a suitable operating environment and is not intended to suggest any limitation as to the scope of use or functionality of the operating environment. Other well known computing devices, environments, and/or configurations that may be suitable for use with embodiments described herein include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments of the invention are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 5 shows an example of a computing device 500 for implementing one or more embodiments of the invention. For example, computer readable instructions for implementing tool 100 may be stored and executed on computing device 500. In another example, computing device 500 may represent a target system for loading and executing a driver constructed using tool 100.

In one configuration, computing device 500 includes at least one processing unit 502 and memory 504. Depending on the exact configuration and type of computing device, memory 504 may be volatile (such as RAM), non-volatile (such as ROM, flash memory, etc.) or some combination of the two. This configuration is illustrated in FIG. 5 by dashed line 506.

In other embodiments, device 500 may include additional features and/or functionality. For example, device 500 may also include additional storage (e.g., removable and/or non-removable) including, but not limited to, magnetic storage, optical storage, and the like. Such additional storage is illustrated in FIG. 5 by storage 508. In one embodiment, computer readable instructions to implement embodiments of the invention may be in storage 508. Storage 508 may also store other computer readable instructions to implement an operating system, an application program, and the like.

The term “computer readable media” as used herein includes computer storage media. Computer storage media includes volatile and nonvolatile, removable and non-removable media implemented in any method or technology for storage of information such as computer readable instructions or other data. Memory 504 and storage 508 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 500. Any such computer storage media may be part of device 500.

Device 500 may also include communication connection(s) 512 that allow device 500 to communicate with other devices. Communication connection(s) 512 may include, but is not limited to, a modem, a Network Interface Card (NIC), an integrated network interface, a radio frequency transmitter/receiver, an infrared port, a USB connection, or other interfaces for connecting computing device 500 to other computing devices. Communication connection(s) 512 may include a wired connection or a wireless connection. Communication connection(s) 512 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, Near Field Communication (NFC), and other wireless media.

Device 500 may include input device(s) 514 such as keyboard, mouse, pen, voice input device, touch input device, infrared cameras, video input devices, and/or any other input device. Output device(s) 516 such as one or more displays, speakers, printers, and/or any other output device may also be included in device 500. Input device(s) 514 and output device(s) 516 may be connected to device 500 via a wired connection, wireless connection, or any combination thereof. In one embodiment, an input device or an output device from another computing device may be used as input device(s) 514 or output device(s) 516 for computing device 500.

Components of computing device 500 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 500 may be interconnected by a network. For example, memory 504 may be comprised of multiple physical memory units located in different physical locations interconnected by a network.

In the description and claims, the term “coupled” and its derivatives may be used. “Coupled” may mean that two or more elements are in contact (physically, electrically, magnetically, optically, etc.). “Coupled” may also mean two or more elements are not in contact with each other, but still cooperate or interact with each other (for example, communicatively coupled).

Those skilled in the art will realize that storage devices utilized to store computer readable instructions may be distributed across a network. For example, a computing device 530 accessible via network 520 may store computer readable instructions to implement one or more embodiments of the invention. Computing device 500 may access computing device 530 and download a part or all of the computer readable instructions for execution. Alternatively, computing device 500 may download pieces of the computer readable instructions, as needed, or some instructions may be executed at computing device 500 and some at computing device 530. Those skilled in the art will also realize that all or a portion of the computer readable instructions may be carried out by a dedicated circuit, such as a Digital Signal Processor (DSP), programmable logic array, and the like.

Various operations of embodiments of the present invention are described herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment of the invention.

The above description of embodiments of the invention, including what is described in the Abstract, is not intended to be exhaustive or to limit the embodiments to the precise forms disclosed. While specific embodiments and examples of the invention are described herein for illustrative purposes, various equivalent modifications are possible, as those skilled in the relevant art will recognize in light of the above detailed description. The terms used in the following claims should not be construed to limit the invention to the specific embodiments disclosed in the specification. Rather, the following claims are to be construed in accordance with established doctrines of claim interpretation.

What is claimed is:

1. A method, comprising:
generating a driver model that describes the configuration of one or more driver objects;
receiving developer driver code;
compiling the driver model and the developer driver code to generate a driver including a machine readable driver model and compiled developer driver code, wherein the machine readable driver model and the complied developer driver code are independently serviceable; and
outputting the driver.

2. The method of claim 1, further comprising:
selecting the one or more driver objects from a group of driver objects.

3. The method of claim 2, further comprising:
configuring the one or more driver objects.

4. The method of claim 3 wherein configuring the one or more driver objects includes configuring properties, methods, and events for a driver object.

5. The method of claim 1, further comprising:
validating that the driver model is in compliance with driver usage rules.

6. The method of claim 1 wherein compiling the driver includes generating binding code for the driver, wherein the binding code includes code for binding of the driver model to the developer driver code.

7. The method of claim 1 wherein the driver developer code includes event handler code for the device driver.

8. The method of claim 1 wherein the one or more driver objects include one or more Windows Driver Foundation objects.

9. One or more computer readable media including computer readable instructions that when executed perform the method of claim 1.

10. One or more computer readable media including computer readable instructions when executed by a target computing device perform operations comprising:
receiving a driver at the target computing device, the driver including:
a machine readable driver model that describes the configuration of one or more driver objects stored in a library on the target computing device; and
compiled developer driver code bound to the machine readable driver model, wherein the machine readable driver model and the compiled developer driver code are independently serviceable; and
compiling the driver on the target computing device.

11. The one or more computer readable media of claim 10 wherein compiling the driver includes compiling the driver with an ahead of time compiler on the target computing device.

12. The one or more computer readable media of claim 10 wherein compiling the driver includes:
configuring one or more driver objects stored in the library in accordance with the machine readable driver model; and
compiling the configured one or more driver objects.

13. The one or more computer readable media of claim 10 wherein the computer readable instructions when executed further perform operations comprising:
receiving updates to the driver from another computing device, wherein the machine readable driver model and the compiled developer driver code may be updated independently of each other.

14. The one or more computer readable media of claim 10 wherein the computer readable instructions when executed further perform operations comprising:
loading the driver into kernel space of the target computing device when the driver is verified safe.

15. The one or more computer readable media of claim 10 wherein the computer readable instructions when executed further perform operations comprising:
loading the driver into user space of the target computing device when the driver is not verified safe.

16. The one or more computer readable media of claim 10 wherein the one or more driver objects include one or more Windows Driver Foundation objects.

17. A system, comprising:
one or more processing units; and
one or more computer readable media having a model based device driver code generation tool executable by the one or more processing units, the model based device driver code generation tool comprising:
a driver object manager to generate a driver model that describes the configuration of one or more driver objects; and
a compiler to bind the driver model to developer driver code to generate a driver file having a machine readable driver model and compiled developer driver code, wherein the machine readable driver model and the compiled developer driver code are independently serviceable.

18. The system of claim 17 wherein the model based device driver code generation tool includes a user interface to allow a user to select representations of the driver objects and to configure the selected driver objects.

19. The system of claim 17 wherein the compiler includes a validation tool, the validation tool to determine if the driver model is in compliance with driver usage rules.

20. The system of claim 17 wherein the driver file includes a code behind file, wherein the code behind file includes developer driver code.
